(19) United States
(12) Patent Application Publication
(10) Pub. No.: US 2026/0168323 A1
(43) Pub. Date: Jun. 18, 2026

(54) A CLOSURE SYSTEM

(71) Applicant: LOCINOX, Waregem (BE)

(72) Inventor: Joseph TALPE, Heestert-Zwevegem (BE)

(73) Assignee: LOCINOX, Waregem (BE)

(21) Appl. No.: 19/421,102

(22) Filed: Dec. 16, 2025

(30) Foreign Application Priority Data
Dec. 16, 2024 (EP) 24220044.2

(51) Int. Cl. E06B 11/02; E05F 15/614

(52) U.S. Cl. CPC E06B 11/02; E05F 15/614

(57) ABSTRACT

An electrically operated closure system comprising: a pivotable gate; a mounting foot (30) comprising a first set of support members (52); a bearing frame (11) fixed to the mounting foot with the pivotable gate being hingedly connected to the bearing frame; and an actuator (4) partially positioned inside the mounting foot, the actuator comprising: an output member (20) onto which the pivotable gate is mounted; and a second set of support members (55) which corresponds to said first set of support members, wherein the actuator is supported inside the mounting foot by intercoupling of the first and second sets of support members. By virtue of the various fixation openings and support members, the gate post and actuator can be readily assembled without requiring complex operations by common fixation elements.

### TECHNICAL FIELD

The present invention relates to a closure system and a method for at least partially assembling the closure system.

### BACKGROUND ART

In the field of outdoor closure systems there are generally two kinds of gate posts, namely a support gate post on which the closure member is attached and a free gate post against which the closure member closes. In view of their different functions, the gate posts are usually different in size, shape, material, rigidity, etc.

In the context of support gate posts, there are various ways on how to mount the closure member to the gate post. This may involve rail assemblies, hinge assemblies, gate closers, gate actuators, etc. Moreover, for each assembly, various kinds exist. For example, hinges may be front mounted, rear mounted, or side mounted. Gate closers may act on the closure member or on the hinge. The gate may be centrally aligned with respect to the gate posts, but other alignments are known, e.g. front or rear alignment.

Furthermore, different types of gate actuators are known in the art, for example spring-biased gate actuators as disclosed in WO 2012/103572 that are intended solely for closing the gate; hydraulically damped spring-biased gate actuators as disclosed in WO 2018/228729 that are intended solely for closing the gate; and motorized gate actuators which are operated by an electric drive as disclosed in WO 2019/048359 that are intended for opening and closing the gate. Due to the use of an electric drive, which thus serves for both the opening and closing of the gate, this kind of gate actuator is also often referred to by the term “gate opener”.

Moreover, there are various configurations known on where and how to provide the electric drive for the gate actuation. Commonly, the drive is provided separately from the closure system, e.g. adjacent the closure system or positioned in a dedicated space in the ground. The drive can also be provided on the outside of the gate post, e.g. as disclosed in WO 2019/048359, or integrated in the gate post, e.g. as in EP 2 966 251.

In general, due to the number of possible configurations of closure systems and consumer demands, manufacturers and retailers are required to have a large stock of parts in order to meet consumer needs. There is also a large amount of customization and on-site assembly required especially when replacing a closure system in an already present enclosure.

### DISCLOSURE OF THE INVENTION

It is an object of the present invention to provide a closure system which at least partially alleviates one or more of the above-mentioned disadvantages.

According to the present invention, this is achieved with a closure system comprising: a pivotable gate; a mounting foot extending in an upright direction between a lower end and an upper end, the mounting foot comprising: a first set of fixation openings; and a first set of support members near its lower end and comprising at least two support members which are located on opposite sides of the mounting foot; a bearing frame extending in the upright direction between a lower end and an upper end with the pivotable gate being hingedly connected to the bearing frame, the bearing frame comprising: a second set of fixation openings which corresponds to said first set of fixation openings, wherein the lower end of the bearing frame is fixed to the mounting foot by a plurality of fixation elements which each extend through a respective one of the first and second sets of fixation openings; an actuator which is at least partially positioned inside the mounting foot, the actuator being mainly L-shaped with a first leg extending in the upright direction between a lower end and an upper end and a second leg extending from the lower end outwards in a transverse direction which is perpendicular to the upright direction, the actuator comprising: an output member provided in the second leg with the pivotable gate being mounted onto the output member; and a second set of support members which corresponds to said first set of support members, wherein the actuator is supported inside the mounting foot by intercoupling of the first and second sets of support members.

The present invention provides a ground mounted gate in which the actuator acts at least partially as a support for the pivotable gate. The actuator is integrated in the gate post, which gate post comprises the mounting foot and the bearing frame. By virtue of the various fixation openings and support members, the gate post and actuator can be readily assembled without requiring complex operations (e.g. milling, welding, etc.) by common fixation elements (e.g. bolts, nuts, screws, etc.).

Another advantage of the present invention is that the pivotable gate directly engages the output member of the actuator. There is thus no need for a transmission mechanism.

In practice, the connection between the bearing frame and the ground surface on which it is mounted is of paramount importance since all forces exerted on the bearing frame have to be transferred via the mounting foot to the ground surface. According to the present invention, there is a direct connection between the bearing frame and the mounting foot reducing the risk of intermediate elements not being able to handle the forces involved. The direct connection also inherently involves overlapping and adjacent wall sections of the bearing frame and the mounting foot thereby creating a large contact area improving force transfer and reducing local pressure.

An embodiment of the present invention is wherein the actuator is adjustable with respect to the mounting foot in the transverse direction. Preferably, this adjustability may be achieved in that the first and second sets of support members form a sliding interlock, such as a T-slot or a dovetail, extending in the transverse direction. The tongue section of the sliding interlock is advantageously provided on the first set of support members.

As the pivotable gate is directly mounted on the actuator, it is advantageous to allow adjusting the position of the actuator with respect to mounting foot. More specifically, the clearance between the pivotable gate and the gate post is determined by the placement of the actuator with respect to the mounting foot. As such, adjusting this distance, allows to adjust the gate-gate post clearance. The use of a sliding interlock (e.g. a T slot, a dovetail groove, etc.) is a convenient manner to allow such a sliding motion, in particular in a near continuous manner, whilst maintaining the essential function of the support members (i.e. preventing that the actuator can move in any other direction with respect to the mounting foot).

Providing the tongue section of the sliding interlock as part of the first support members, i.e. as part of or on the mounting foot), is desired from a practical point of view. More specifically, the reverse situation where the groove section is provided on the mounting foot requires a less compact design. For example, the mounting foot should have a sufficiently thick wall to provide a groove therein or a relatively high rail should be provided which is high enough to provide the groove with adjacent space for fastening to the mounting foot. Whereas the tongue section can be more easily be provided by a thin rail element.

An embodiment of the present invention is wherein a spacer is provided between the mounting foot and one of said at least two support members, the spacer extending in a direction which is perpendicular to the upright direction and to the transverse direction, the spacer preferably being cut at length from an extrusion profile.

The provision of a spacer allows to adjust the actuator with respect to the mounting foot in the depth direction. More specifically, the alignment between the pivotable gate and the gate post is determined by the placement of the actuator with respect to the mounting foot in the depth direction. The spacer thus allows to provide a central alignment, a front or rear alignment or generally any desired alignment.

Cutting the spacer at length from an extrusion profile allows for an exact and custom alignment to be achieved which may be particularly advantageous in case of an installation in an existing enclosure where a gate stop may already be installed in the ground.

An embodiment of the present invention is wherein the mounting foot is provided with a further set of fixation openings near its lower end, the first set of support members being fixed to the mounting foot by a plurality of fixation elements which each extend through a respective one of said further set of fixation openings into a threaded hole provided in a respective one of the first set of support members, the plurality of fixation elements preferably further extending through an opening provided in the bearing frame.

The provision of the further set of fixation openings for the first set of support members avoids a misplacement of the support members. Furthermore, it allows readily assembling the support members to the mounting without requiring complex operations (e.g. milling, welding, etc.) by common fixation elements (e.g. bolts, nuts, screws, etc.). If spacers are present, these are naturally affixed using the same fixation elements which thus extend through the length of the spacer.

Extending the fixation elements also through the bearing frame creates a stronger gate post. More specifically, additional connections are formed between the mounting foot and the bearing frame.

An embodiment of the present invention is wherein the bearing frame has a further second set of fixation openings which is identical to said second set of fixation openings, wherein the second set and the further second set are spaced apart from one another in the upright direction by a height, and in that, when the mounting foot is configured to be mounted with its lower end on a ground surface, each of said plurality of fixation elements extends through one of said first set of fixation openings and a corresponding one of the upper one of the two identical second sets of fixation openings, and when the mounting foot is configured to be mounted with its lower end sunk into the ground surface, each of said plurality of fixation elements extends through one of said first set of fixation openings and a corresponding one of the lower one of the two identical second sets of fixation openings, the height being equal to the distance by which the mounting foot is sunk into the ground surface.

Providing multiple sets of second fixation openings in the bearing frame enables fastening the bearing frame to the mounting foot in multiple different vertical positions. More specifically, the bearing frame can be moved upwards or downwards with respect to the mounting foot. This is advantageous to account for different installation setups, namely one where the mounting foot is on the ground surface and one where the mounting foot is sunk into the ground surface. As the bearing frame should ideally be near the ground surface, it is advantageous to allow shifting the bearing frame upwards in cases where the mounting foot is sunk into the ground surface.

An embodiment of the present invention is wherein the mounting foot has a substantially flat lower surface configured to be positioned on a ground surface. Preferably, the bearing frame is provided with a recess at its lower end through which the second leg of the actuator extends.

In this embodiment, the entire closure system is mounted on top of the ground surface. This avoids having to provide recesses in the ground. The recess allows the second leg of the actuator to extend beyond the gate post as required in order to mount the pivotable gate thereon. The recess can be premade, or made during assembly in the factory, or only made during the final installation on site.

An embodiment of the present invention is wherein the mounting foot is substantially L-shaped with a first leg extending in the upright direction and a second leg extending from the lower end outwards in the transverse direction, the second leg having a substantially flat upper surface, and in that the mounting foot is configured to be mounted with its lower end sunk into the ground surface such that the substantially flat upper surface of the second leg is flush with the ground surface. Preferably, the first leg of the actuator is positioned substantially within the first leg of the mounting foot and in that the second leg of the actuator is positioned substantially within the second leg of the mounting foot.

In this embodiment, the gate post is partially sunk into the ground surface. This allows reducing the clearance between the gate and the ground which may be desirable. In order to protect the actuator which is thus also partially sunk, it is advantageous to provide the L-shaped mounting foot which encases the actuator.

An embodiment of the present invention is wherein the lower end of the mainly L-shaped actuator is spaced apart from the lower end of the mounting foot in the upright direction.

This avoids a direct contact between the surface on which the mounting foot is positioned and the actuator. This may be advantageous to avoid damaging the actuator, e.g. in case of light flooding, in case this surface is not entirely flat, etc.

An embodiment of the present invention is wherein the mounting foot is provided at its lower end with one or more flanges, each flange having one or more openings configured to receive a fastening member to fasten the mounting foot to the ground surface.

The flanges provide a large support area for placing the mounting foot in a stable manner. The provision of the fastening openings again reduces needlessly complex operations during installation of the closure system.

An embodiment of the present invention is wherein said first set of fixation openings are provided near a lower end of the mounting foot, which mounting foot is further provided with additional first sets of fixation openings provided in an upper part of the mounting foot, and in that the bearing frame further comprises additional second sets of fixation openings which corresponds to said additional first sets of fixation openings, wherein the bearing frame is fixed to the mounting foot by a plurality of fixation elements which each extend through a respective one of the additional first and second sets of fixation openings

In this way, the bearing frame is fixed to the mounting foot at various heights thus creating a stronger gate post.

A preferred embodiment of the present invention is wherein each set of the second set of fixation openings and the additional second sets of fixation openings are identical and are preferably uniformly distributed along an upwards extending section of the bearing frame.

The use of identical sets of openings allows relying on a same fixation pattern at different locations and/or for different elements. Providing uniform sets of openings allows reusing a same manufacturing pattern to form different lengths of bearing frames in a simple and expedient manner.

A preferred embodiment of the present invention is wherein each opening of the first set of fixation openings and the additional first sets of fixation openings is provided with an associated elongated slot spaced therefrom in the upright direction, and in that a non-circular nut element is placed in each elongated slot in the mounting foot and aligned with the respective fixation opening.

A non-circular nut element, such as a clip nut, avoids a thick wall being required to provide a threaded area. Rather, the clip nut allows a thin walled structure where the nut is then clipped on. An elongated slot is advantageous as it allow sliding the clip nut into the desired position. It may also be easier to provide sufficient space for inserting the clip nut into the slot sideways.

An embodiment of the present invention is wherein each set of fixation openings comprises at least two openings that are located opposite one another in a depth direction which is perpendicular to the upright direction and the transverse direction.

The various connections are thus always formed between two opposite walls creating a steady and robust closure system. This further reduces the risk of misaligning certain elements and reduces the risk of torsional force effects occurring.

An embodiment of the present invention is wherein the output member of the actuator comprises an output shaft.

Whilst the output member can generally be either an output shaft or a toothed opening, providing the output shaft on the actuator is advantageous. This causes a space reduction for the second leg of the actuator which can thus be generally made thinner with the output shaft sticking out in the upwards direction. A thinner second leg allows to place the pivotable gate closer to the ground surface thus reducing the ground-gate clearance.

An embodiment of the present invention is wherein the actuator comprises an electrically operated actuator. This provides a closure system that can be opened and closed in an automated manner, making it very suitable to acts as a vehicle passage.

The present invention further relates to a method for at least partially assembling closure system described above, the method comprising: placing the actuator inside the mounting foot; sliding the bearing frame over the mounting foot; using the fixation elements to join the mounting foot, the actuator and the bearing frame together to form a gate post; and providing the gate post and the pivotable gate to be mounted on a ground surface.

This method relies on the unique advantage provided by the various parts of the closure system, namely that the entire gate post with actuator can be assembled in the manufacturing process and then transported to the installation site. This assembly is thus done in a neat and organized environment thus reducing the risk of errors occurring. The end installation can then be done by common practitioners without requiring a detailed knowledge on the gate post assembly.

### BRIEF DESCRIPTION OF THE DRAWINGS

The invention will be further explained by means of the following description and the appended figures.

FIGS. 1A and 1B show a first embodiment of a closure system according to the present invention.

FIG. 2 shows an exploded view of the gate post of FIGS. 1A and 1B.

FIGS. 3A and 3B show a second embodiment of a closure system according to the present invention.

FIG. 4 shows an exploded view of the gate post of FIGS. 3A and 3B.

FIG. 5 shows the assembled gate post of FIGS. 3A and 3B without the finishing cover profiles.

FIG. 6A shows a vertical cross-section through a clip nut mounted on the mounting foot.

FIG. 6B shows a vertical cross-section through the assembled mounting foot and bearing frame.

### DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under, left, right, front, back, and the like in the description and the claims are used for descriptive purposes. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

The term “substantially” comprises variations of +/−10% or less, preferably +/−5% or less, more preferably +/−1% or less, and even more preferably +/−0.1% or less, of the specified state, as far as the variations are applicable to function in the present invention. It is to be understood that the term “substantially A” is intended to include “A”.

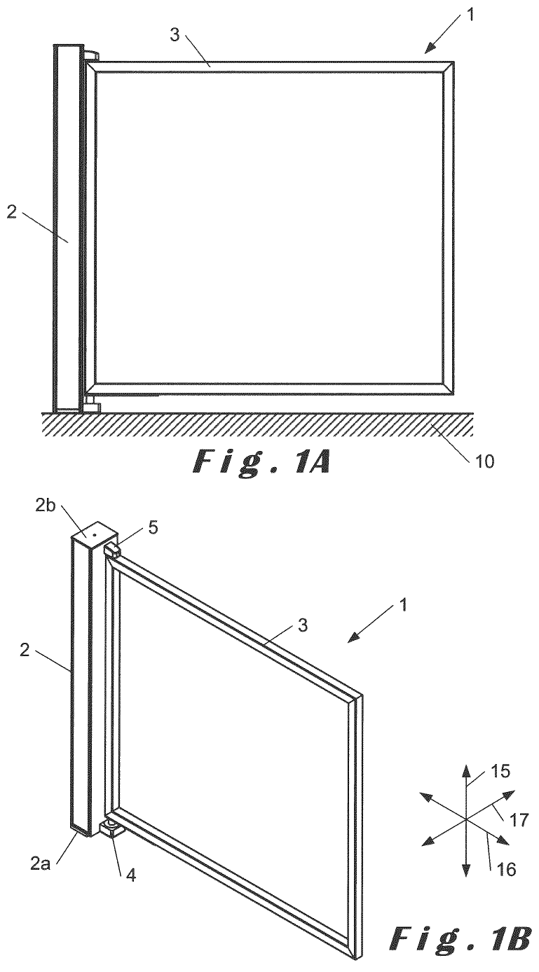

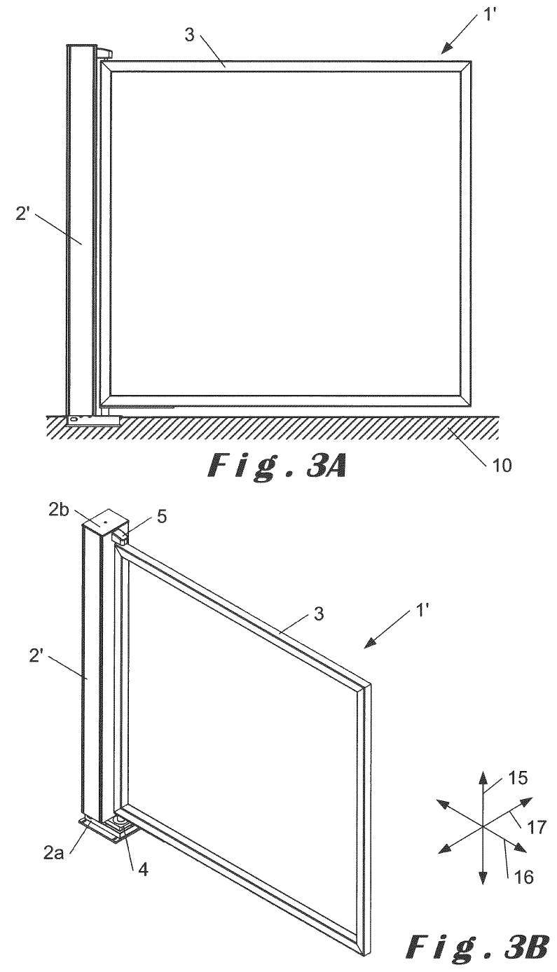

The invention generally relates to a closure system, in particular an outdoor closure system, which is part of an enclosure. FIGS. 1 and 3 illustrate two embodiments of such a closure system with the main difference being the relation of the closure system and the ground surface.

FIGS. 1A and 1B show a first closure system 1 comprising a support gate post 2 which acts as a support for a pivotable gate 3 (or more generally a closure member, such as a gate, a door, or a window). The gate post 2 extends along the upright direction 15 between a lower end 2a and an upper end 2b. The gate 3 is connected to the gate post 2 by means of an upper hinge 5. The lower end of the gate 3 is directly supported by the actuator 4 which is mostly integrated in the gate post 2.

The closure system 1 illustrated in FIGS. 1A and 1B is intended to be mounted directly on top of a ground surface 10. In other words, the lower end 2a of the gate post 2 is resting directly on the ground surface 10.

FIGS. 3A and 3B show a second closure system 1′ comprising a support gate post 2′ which acts as a support for a pivotable gate 3 (or more generally a closure member, such as a gate, a door, or a window). The gate post 2′ extends along the upright direction 15 between a lower end 2a and an upper end 2b. The gate 3 is connected to the gate post 2′ by means of an upper hinge 5. The lower end of the gate 3 is directly supported by the actuator 4 which is mostly integrated in the gate post 2′.

The closure system 1′ illustrated in FIGS. 3A and 3B is intended to be mounted partially inside the ground surface 10. More specifically, the lower end 2a of the gate post 2′ is sunk into the ground surface 10 as best shown in FIG. 3A.

The upper hinge 5 in the closure systems 1, 1′ can be any kind of hinges known in the art and may particularly be eyebolt hinges for example as disclosed in EP 1 528 202, EP 2 778 331 or EP 3 162 997 the content of which are incorporated herein by reference.

The general directions and orientations are also indicated in FIGS. 1B and 3B. More specifically, there is the upright direction 15, the width direction 16 and the depth direction 17. These three directions 15, 16, 17 are generally substantially perpendicular to one another. The upright direction 15 in practice substantially coincides with the vertical direction. The width and dept directions 16, 17 together form a substantially horizontal plane.

An aspect of the present invention is that the same or very similar components can be used to form both types of closure systems 1, 1′ illustrated in FIGS. 1A and 3A. Where components are the same between both embodiments of the closure system, they will be indicated with the same reference number. Where components are different between both embodiments of the closure system but with the same main functionality, they will be indicated with the same reference number with a prime (′) symbol.

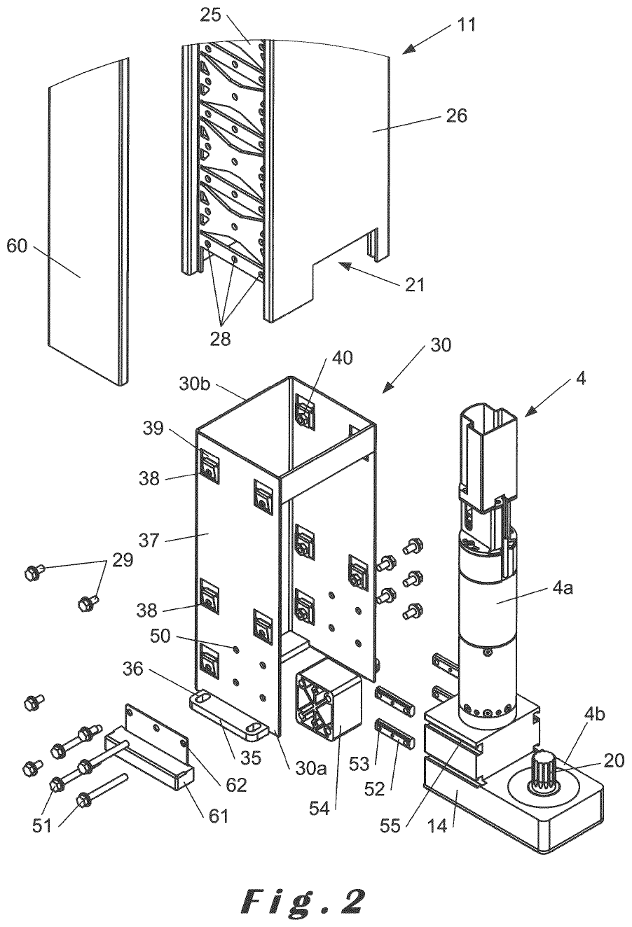

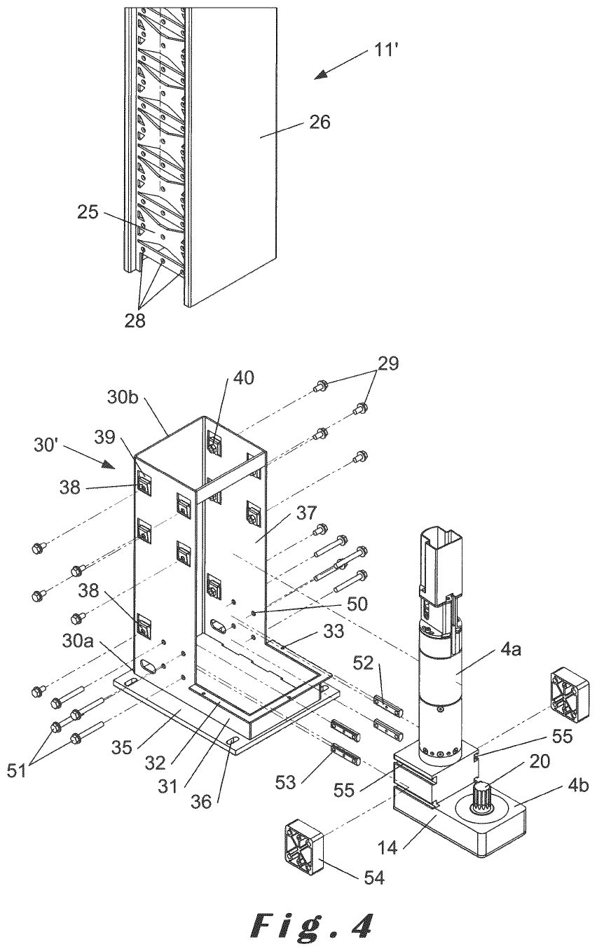

As illustrated in FIGS. 2 and 4, the closure systems 1, 1′ according to the present invention each comprise the same basic components, namely: a pivotable gate 3, a mounting foot 10, 10′, an actuator 4, and a bearing frame 11, 11′. The mounting foot 10, 10′, the bearing frame 11 and the actuator 4 together form the gate post 2, 2′.

The actuator 4 is generally L-shaped with a first leg 4a extending in the upright direction 15 and a second leg 4b extending in the width direction 16. The first leg 4a is integrated within the gate post 2, 2′ and the second leg 4b extends beyond the gate post 2, 2′ so that the pivotable gate 3 can be supported thereon. Both legs 4a, 4b meet in a lower housing section 14. In both closure system embodiments 1, 1′, the actuators 4 are identical.

The second leg 4b is provided with an output shaft 20 (also known as a gear shaft) on which the gate 3 is mounted. However, it should be clear that the output shaft 20 may also be replaced by a gear hole in which case the gear shaft is then provided on the gate 3.

In the illustrated embodiment, the actuator 4 is an electrically operated actuator comprising an electric drive and a transmission ending in the output shaft 20. The electric drive is formed by the various components in the first leg 4a, whereas the transmission is integrated within the lower housing section 14 and/or the second leg 4b. It will be readily apparent that, in other embodiments, the electric drive may be replaced by a spring-biased mechanism or a hydraulically damped spring-biased mechanism with a suitable transmission. In this way, the closure systems according to the present invention are useable for both pedestrian gates and vehicle gates.

In general, the gate post 2, 2′ has four walls. More specifically, each gate post has: a gate facing wall which faces the closure member 3, an opposite wall facing away from the closure member 3, a front wall which normally faces outward from the enclosed area, and a back wall which normally faces the enclosed area.

The bearing frames 11, 11′ are partially shown in FIGS. 2 and 4. The bearing frames 11, 11′ are almost identical for both closure system embodiments 1, 1′. The only difference is that bearing frame 11 is provided with a recess 21 at its lower end, which recess is absent in bearing frame 11′. The reason for this recess 21 is to allow the actuator 4 to extend therethrough in the ground-mounted closure system 1. In the ground-submerged closure system 1′, such a recess is not required as the actuator 4 extends underneath the lower end of the bearing frame 11′. Besides the presence/absence of the recess 21, the bearing frames 11, 11′ are further identical.

The bearing frame 11, 11′ extends in the upright direction 15. The bearing frame 11 is the main structural component of the gate post 10 and as such needs to be able to bear the weight and forces associated with a closure member 3 mounted thereon. In order to achieve the desired strength and rigidity, the bearing frame 11 is generally an integrally formed component. This may be achieved by extruding the bearing frame 11 from a metal, e.g. aluminium. This may also be achieved by hot-rolling or cold-rolling a seamless metal, e.g. steel, tube. The various openings and cut-outs described later may be created by removing excess material (e.g. by laser cutting, milling, etc.) from the extruded, hot rolled or cold rolled metal tube. Various thicknesses may be used for the metal of the bearing frame 11 with suitable values being between 1 mm and 1 cm, for example 2 mm, 3 mm, 4 mm, 5 mm, 6 mm, 7 mm, 8 mm or 9 mm. The thickness depends also on the specific metal used and the manufacturing technique.

The bearing frame 11, 11′ generally has a front and back wall jointly denoted by reference number 25 and two side walls jointly denoted by reference number 26. The side walls 26 extend in the depth direction 17, whereas the front/back walls 25 extend in the width direction 16.

Another important aspect in achieving the desired strength and rigidity, is the cross-sectional shape of the bearing frame 11, 11′ in the horizontal plane. This shape is generally I shaped. This shape is caused in that the front/back walls 25 are recessed with respect to the outermost sections of the sidewalls 26. The result is that each corner of the bearing frame 11, 11′ comprises two parallel wall sections with a 180°fold. Due to this shape, each corner has a high rigidity and strength and does not easily buckle under high pressure. As an example, each parallel wall section may overlap in the depth direction 17 for about 1 cm to 3 cm and may be separated by a distance in the width direction 16 of about 0,5 cm to 2 cm. Naturally other specific dimensions are possible and linked with the material selection. This shape provides a very high rigidity thus avoiding to use very thick metal sheets (e.g. 2 cm or more) to form the bearing frame 11, 11′. Such thickness, while providing the desired strength and rigidity, would negatively impact the weight, costs, size, etc. of the bearing frame 11, 11′.

As shown in FIGS. 2 and 4, both the front wall 25 forms a substantially flat area in which a repeating pattern of openings is provided. This same pattern is provided in the back wall 25 as well. This repeating pattern is disclosed in detail in the unpublished European patent application 24160956.9 incorporated herein by reference.

In relation to the closure system 1, 1′ of the present invention, the most relevant aspect of the repeating pattern of openings are the three fixation openings 28 aligned with one another in the width direction 16. It will be appreciated that the openings 28 could be misaligned with the width direction with tolerances of up to 10°offset being possible so that either the left or the right opening is higher or lower than the other. The openings 28 are symmetrical about the middle upright plane. These identical three fixation openings 28 are uniformly distributed in the upright direction 15 along the bearing frame 11, 11′. A separation in the upright direction 15 between each three fixation openings 28 may generally be about 2 cm, about 3 cm or about 4 cm. This allows identical structural end/or functional components to be fixed on the bearing frame 11, 11′ at different height locations without modification.

As used herein, the term “set of fixation openings” is intended to refer to at least two openings one of which is in the front wall of the gate post and one of which is in the back wall of the gate post, the two openings being aligned with one another in the upright direction 15 and the width direction 16. For example, a set of fixation openings in the bearing frame is thus intended to refer to one of the three openings 28 in the front wall 25 and its corresponding one in the back wall 25 which is located at the same height and width position.

Each fixation opening 28 is dimensioned to receive a threaded fastening member 29. In this context, the use of circular openings 28 is advantageous, albeit not necessary. In the illustrated embodiment, the openings 28 are dimensioned to receive M8 threaded fastening members.

In order to connect the bearing frame 11, 11′ with the ground surface 10 on which the gate post 2, 2′ is mounted, a mounting foot 30, 30′ is provided. The first mounting foot 30 is shown in FIG. 2 and is intended to be placed on top of the ground surface 10. The second mounting foot 30′ is shown in FIG. 4 and is intended to be partially submerged in the ground surface 10

The main difference between mounting foots 30, 30′ is the additional leg 31 in mounting foot 30′. This additional leg 31 causes the mounting foot 30′ to be generally L-shaped in correspondence to the L-shaped actuator 4. This additional leg 31 acts as an encasement for the actuator 4 as this would otherwise be exposed to the surrounding ground surface 10. The additional leg 31, as best shown in FIG. 3, is submerged into the ground surface 10. The top of the additional leg 31 forms a substantially flat surface that is intended to be flush with the ground surface 10.

In the illustrated embodiment, a surrounding flange 32 is provided at the top of the additional leg 31. Several fixation openings 33 are provided in the flange 32. This flange 32 with fixation openings 33 may be used to mount a cover plate (not shown) thereon reducing the risk of dirt, water, and the like to interact with the actuator 4.

Besides the presence/absence of the additional leg 31, the mounting foots 30, 30′ are substantially the same. The mounting foot 30, 30′ extends in the upright direction 15 between a lower end 30a and an upper end 30b.

The lower end 30a is provided with a flange 35. This flange 35 may be continuous as illustrated in FIG. 4 or may be split in several parts as illustrated in FIG. 2. Several fixation openings 36 are provided in the flange 35. This flange 35 with fixation openings 36 is used to mount the foot 30, 30′ to the ground surface.

The mounting foot 30, 30′ has a front wall and a back wall, both of which are designated with reference number 37, which both extend in the upright direction 15. In the front/back walls 37, various fixation openings 38 are provided. Once the bearing frame 11, 11′ is slid onto the mounting foot 30, 30′, fixation members 29 are used to fix these components together.

These fixation openings 38 are provided in a repeating pattern corresponding to the fixation openings 28 in the bearing frame 11, 11′. To that end, each wall 37 is provided with an upper pair and a lower pair of openings 38 to ensure a strong connection between the bearing frame 11, 11′ and the mounting foot 30, 30′. This is further aided by the large contact surface area between the walls of the mounting foot 30, 30′ and the walls of the bearing frame 11, 11′.

In the illustrated embodiment, there are no central fixation openings in the mounting foot 30, 30′ which would correspond to those in the bearing frame 11, 11′. These could be provided to enhance the connection further.

The mounting foot 30, 30′ is preferably at least 10 cm or 15 cm high so that multiple opening pairs 28, 38 overlap between the mounting foot and the bearing frame.

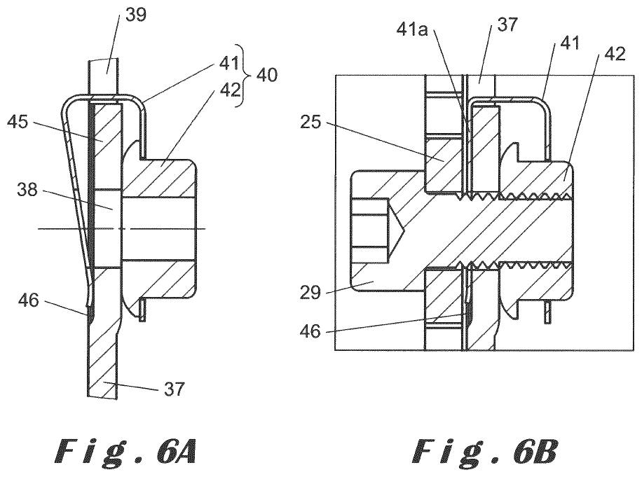

As the fixation openings 38 are made in a relatively thin metal plate, it is challenging to provide a thread therein. To this end, clip nuts 40 are provided. These are better illustrated in FIGS. 6A and 6B where FIG. 6A illustrates a clip nut 40 placed on the mounting foot 30, 30′ and where FIG. 6B illustrates the same once the bearing frame 11, 11′ has been attached.

A clip nut 40 generally comprises a clip section 41 and a nut section 42 which provides an inner threaded area. For each fixation opening 38 where a clip nut 40 is needed to provide a threaded area, an elongated opening 39 is provided adjacent the fixation opening 38. This elongated opening 39 allows sliding the clip nut 40 therethrough so that the threaded area aligns with the fixation opening 38. The clip section 41 is formed by a U-shaped member in the illustrated embodiment so that this may easily be clipped on a free edge of the elongated opening 39 as shown in FIG. 6A.

Important to note in FIG. 6A is that the plate section 45 in which the fixation opening 38 is formed is slightly shifted in the depth direction 17 in comparison to the remainder wall 37 of the mounting foot 30, 30′. This slight shift may be achieved due to a stamping operation for example. The reason for this is clear from FIG. 6B. The depression creates a space 46 in which the front part 41a of the clip 41 fits. This ensures that the mounting foot and bearing frame are (within manufacturing tolerances) as flush as possible without creating a local deformation due to the clip nut 40.

Returning to FIGS. 2 and 4, the placement of the actuator 4 in the mounting foot 30, 30′ will be described. To this end, the mounting foot 30, 30′ comprises further fixation openings 50 via which elongated support members 52 are mounted. The further fixation openings 50 again rely on the same pattern as that in the bearing frame 11, 11′ to maximise interoperability and compatibility. In the illustrated embodiment, an upper pair and a lower pair of openings 50 are provided to allow mounting two supports 52 on each wall 37. Fasteners 51 are provided to fasten the supports 52 to the mounting foot 30, 30′. These fasteners 51 engage in threaded openings 53 provided in the supports 52.

The support members 52 may be spaced from the walls 37 due to the presence of one or more spacers 54. The spacer 54 may be cut at length from an extrusion profile. The spacer is positioned between the walls 27 and the support members 52 and is fixed by use of the same fasteners 51. The spacers 54 are used to vary the position of the actuator 4 with respect to the mounting foot 30, 30′ in the depth direction 17.

The lower housing section 14 of the actuator 4 is provided with elongated slots 55. The support members 52 are received in these slots 55. Prior to tightening the fasteners 51, the supports 52 and slots 55 form an interlock slide (e.g. a T-slot, dovetail, etc.) which allow the actuator 4 to slide with respect to the mounting foot 30, 30′ in the width direction 16. Tightening the fasteners 51 prevents such a sliding motion.

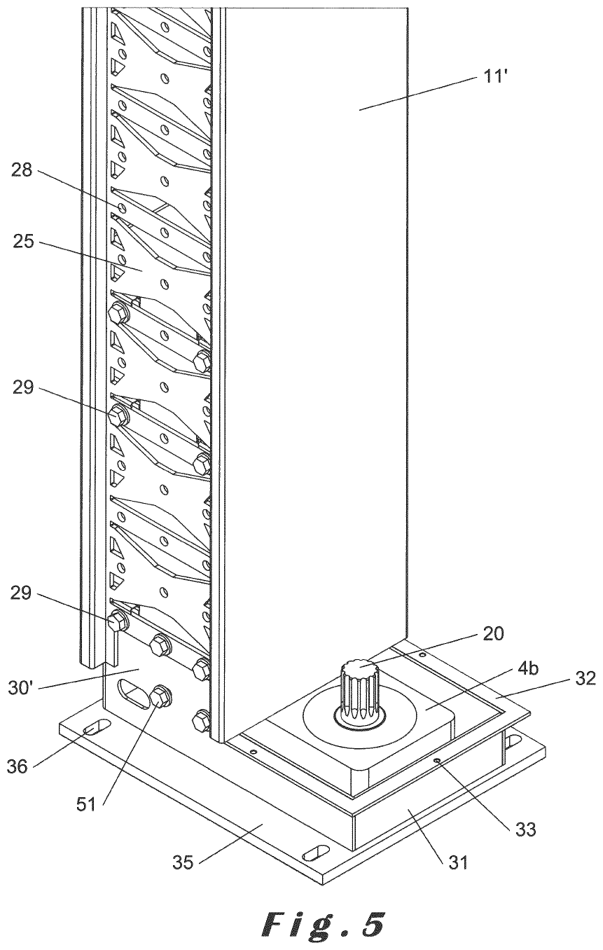

In general, as part of the present invention, the entire closure system 1, 1′ may be assembled only by means of threaded fastening members, clip nuts and sawing. Importantly, no welding is required. As such, all gate post components can have its final finish (e.g. powder lack) already applied during the manufacturing process. This is for example in part shown in FIG. 5 where the gate post 2′ shown in exploded view in FIG. 4 has been assembled. This gate post 2′ can then be shipped together with the gate 3 to the installation site where it may be readily mounted on the ground surface 10 without requiring a skilled technician.

On a final note, the gate post may comprise one or more cover profiles. One such cover profile 60 is shown in part in FIG. 2. Such a cover profile 60 and how it is mounted on the bearing frame 11, 11′ is disclosed in detail in the unpublished European patent application 24160956.9 incorporated herein by reference. Other covering components may of course be provided as desired, for example the flange cover 61 shown in FIG. 2. This flange cover 61 has again fixation openings 62 following the same pattern as those in the bearing frame 11, 11′ thus maximizing component compatibility and ease of assembly.

Although aspects of the present disclosure have been described with respect to specific embodiments, it will be readily appreciated that these aspects may be implemented in other forms within the scope of the invention as defined by the claims.

1. A closure system (1, 1′) comprising:
a pivotable gate (3);
a mounting foot (30, 30′) extending in an upright direction (15) between a lower end (30a) and an upper end (30b), the mounting foot comprising:
a first set of fixation openings (38); and
a first set of support members (52) near its lower end and comprising at least two support members which are located on opposite sides of the mounting foot;
a bearing frame (11, 11′) extending in the upright direction between a lower end and an upper end with the pivotable gate being hingedly connected to the bearing frame, the bearing frame comprising:
a second set of fixation openings (28) which corresponds to said first set of fixation openings, wherein the lower end of the bearing frame is fixed to the mounting foot by a plurality of fixation elements (29) which each extend through a respective one of the first and second sets of fixation openings;
an actuator (4) which is at least partially positioned inside the mounting foot, the actuator being mainly L-shaped with a first leg (4a) extending in the upright direction between a lower end and an upper end and a second leg (4b) extending from the lower end outwards in a transverse direction (16) which is perpendicular to the upright direction, the actuator comprising:
an output member (20) provided in the second leg with the pivotable gate being mounted onto the output member; and
a second set of support members (55) which corresponds to said first set of support members, wherein the actuator is supported inside the mounting foot by intercoupling of the first and second sets of support members.

2. The closure system according to claim 1, wherein the actuator is adjustable with respect to the mounting foot in the transverse direction.

3. The closure system according to claim 2, wherein the first and second sets of support members form a sliding interlock, such as a T-slot or a dovetail, extending in the transverse direction.

4. The closure system according to claim 1, wherein a spacer (54) is provided between the mounting foot and one of said at least two support members, the spacer extending in a direction (17) which is perpendicular to the upright direction and to the transverse direction, the spacer preferably being cut at length from an extrusion profile.

5. The closure system according to claim 1, wherein the mounting foot is provided with a further set of fixation openings (50) near its lower end, the first set of support members being fixed to the mounting foot by a plurality of fixation elements (51) which each extend through a respective one of said further set of fixation openings into a threaded hole provided in a respective one of the first set of support members, the plurality of fixation elements preferably further extending through an opening provided in the bearing frame.

6. The closure system according to claim 1, wherein the bearing frame has a further second set of fixation openings which is identical to said second set of fixation openings, wherein the second set and the further second set are spaced apart from one another in the upright direction by a height, and
wherein, when the mounting foot is configured to be mounted with its lower end on a ground surface (10), each of said plurality of fixation elements extends through one of said first set of fixation openings and a corresponding one of the upper one of the two identical second sets of fixation openings, and when the mounting foot is configured to be mounted with its lower end sunk into the ground surface, each of said plurality of fixation elements extends through one of said first set of fixation openings and a corresponding one of the lower one of the two identical second sets of fixation openings, the height being equal to the distance by which the mounting foot is sunk into the ground surface.

7. The closure system (1) according to claim 1, wherein the mounting foot has a substantially flat lower surface configured to be positioned on a ground surface (10).

8. The closure system according to claim 7, wherein the bearing frame is provided with a recess (21) at its lower end through which the second leg of the actuator extends.

9. The closure system (1′) according to claim 1, wherein the mounting foot is substantially L-shaped with a first leg extending in the upright direction and a second leg (31) extending from the lower end outwards in the transverse direction, the second leg having a substantially flat upper surface, and
wherein the mounting foot is configured to be mounted with its lower end sunk into a ground surface (10) such that the substantially flat upper surface of the second leg is flush with the ground surface.

10. The closure system according to claim 9, wherein the first leg of the actuator is positioned substantially within the first leg of the mounting foot and in that the second leg of the actuator is positioned substantially within the second leg of the mounting foot.

11. The closure system according to claim 1, wherein the mounting foot is provided at its lower end with one or more flanges (35), each flange having one or more openings (36) configured to receive a fastening member to fasten the mounting foot to the ground surface.

12. The closure system according to claim 1, wherein said first set of fixation openings are provided near a lower end of the mounting foot, which mounting foot is further provided with additional first sets of fixation openings provided in an upper part of the mounting foot, and wherein the bearing frame further comprises additional second sets of fixation openings which corresponds to said additional first sets of fixation openings, wherein the bearing frame is fixed to the mounting foot by a plurality of fixation elements which each extend through a respective one of the additional first and second sets of fixation openings.

13. The closure system according to claim 12, wherein each set of the second set of fixation openings and the additional second sets of fixation openings are identical and are preferably uniformly distributed along an upwards extending section of the bearing frame.

14. The closure system according to claim 12, wherein each opening of the first set of fixation openings and the additional first sets of fixation openings is provided with an associated elongated slot (39) spaced therefrom in the upright direction, and
in that a non-circular nut element (40) is placed in each elongated slot in the mounting foot and aligned with the respective fixation opening.

15. The closure system according to claim 1, wherein each set of fixation openings comprises at least two openings that are located opposite one another in a width direction which is perpendicular to the upright direction and the transverse direction.

16. A method for at least partially assembling closure system (1, 1′) of claim 1, the method comprising:
placing the actuator (4) inside the mounting foot (30, 30′);
sliding the bearing frame (11, 11′) over the mounting foot;
using the fixation elements (29, 51) to join the mounting foot, the actuator and the bearing frame together to form a gate post (2, 2′); and
providing the gate post and the pivotable gate (3) to be mounted on a ground surface (10).
